(19) United States
(12) Patent Application Publication
(10) Pub. No.: US 2006/0135067 A1
(43) Pub. Date: Jun. 22, 2006

(54) Method and apparatus for configuring a WLAN

(76) Inventor: Gregory A. Dunko, Cary, NC (US)

Correspondence Address: COATS & BENNETT/SONY ERICSSON, 1400 CRESCENT GREEN, SUITE 300, CARY, NC, 27511, US

(21) Appl. No.: 11/017,373

(22) Filed: Dec. 20, 2004

(51) Int. Cl. H04B 7/24

(52) U.S. Cl. 455/41.2; 455/456.1

(57) ABSTRACT

A method and apparatus for adapting a wireless terminal to different short-range wireless network requirements based on a region of operation associated with a location of the wireless terminal as described herein. The wireless terminal determines a region of operation associated with the location of the wireless terminal. Exemplary regions of operation may include a country or a group of countries. Based on the determined region of operation, a controller in the wireless terminal configures a short-range wireless transceiver in the wireless terminal to operate within one or more operating parameters.

### BACKGROUND OF THE INVENTION

The present invention relates generally to a short-range wireless network, and more particularly to the operation of wireless local area networks (WLANs) in different regions around the globe.

Short-range wireless networks, i.e., WLANs, use unlicensed frequency bands to communicate information over short distances. Such frequency bands include but are not limited to 2.4-2.4835 GHz, 5.15-5.25 GHz, 5.25-5.35 GHz, and 5.725-5.825 GHz. Due to the lack of an international standard, different regions of the globe use different frequency bands or portions of frequency bands for the same short-range wireless applications. For example, the United States may use a 2.412-2.462 GHz frequency band for WLAN applications, while France may use a 2.457-2.472 GHz frequency band. Further, while the United States and Europe both use the 5.25-5.35 GHz frequency band for WLAN applications, the United States allows this frequency band to be used for both indoor and outdoor applications, while Europe restricts this band to indoor applications.

As the popularity of WLAN and other short-range wireless networks continues to increase, the likelihood of a user traveling through different regions with different short-range network requirements necessarily increases. However, conventional wireless terminals are typically configured with specific operating parameters that correspond only to a specific region. Therefore, conventional wireless terminals will not operate properly in other regions across the globe that require different operating parameters.

### SUMMARY OF THE INVENTION

The present invention comprises a method and apparatus that adapts a wireless terminal to different short-range wireless network requirements in different regions across the globe. In particular, a wireless terminal according to the present invention determines its current regional location. For example, the wireless terminal may determine the country associated with the location of the wireless terminal. Based on the determined region of operation, a controller in the wireless terminal configures the wireless terminal's short-range wireless transceiver to operate within one or more operating parameters, such as a defined WLAN frequency spectrum.

### BRIEF DESCRIPTION OF THE DRAWINGS

FIG. 1 illustrates an exemplary wireless system.

FIG. 2 illustrates a block diagram of one exemplary wireless terminal according to the present invention.

FIG. 3 illustrates one exemplary table of operating parameters for multiple regions of operation.

FIG. 4 illustrates one exemplary method of the present invention.

FIG. 5 illustrates another exemplary method of the present invention.

### DETAILED DESCRIPTION OF THE INVENTION

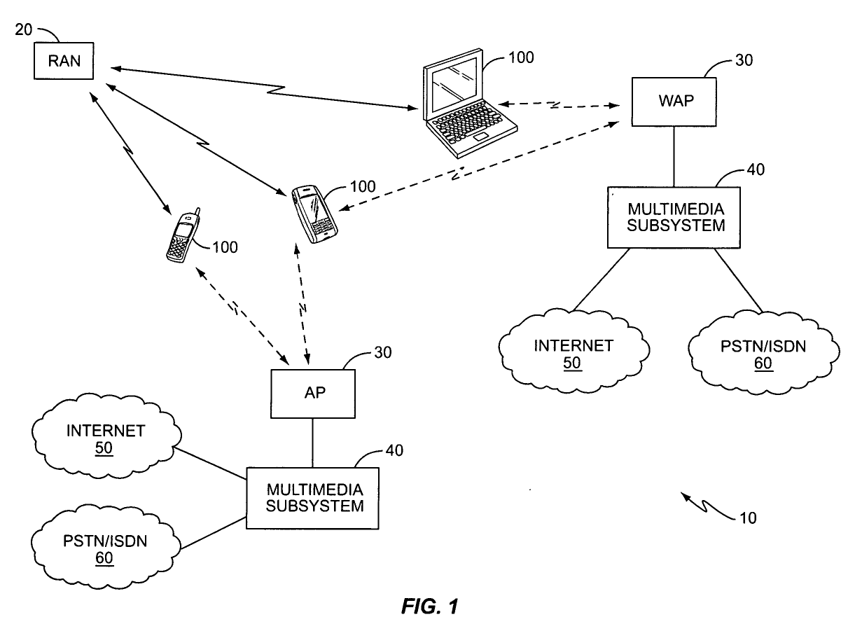

FIG. 1 illustrates an exemplary wireless system 10 that includes at least one Radio Access Network (RAN) 20 and at least one Wireless Access Point (WAP) 30 that interfaces with one or more wireless terminals 100 over a long-range network and a short-range network, respectively. FIG. 1 illustrates a limited number of RANs 20, WAPs 30, and wireless terminals 100 for clarity. However, those skilled in the art will appreciate that wireless system 10 may include any number of RANs 20, WAPs 30, and/or wireless terminals 100.

RAN 20 communicates with wireless terminals 100 via a long-range wireless network, such as a cellular network, according to any known means. As understood by those skilled in the art, RAN 20 and wireless terminals 100 may communicate any known type of information, such as voice, data, or a combination of voice and data. Further, RAN 20 and wireless terminals 100 may communicate this information according to any known communication standard, including but not limited to the standards known generally as GSM (Global System for Mobile Communications), GPRS (General Packet Radio Service), TIA/EIA-136, cdmaOne, cdma2000, UMTS (Universal Mobile Telecommunications System), and Wideband CDMA (Code Division Multiple Access).

Each WAP 30 provides short-range wireless communication links (e.g., WLAN links) to one or more wireless terminals 100. Short-range wireless networks enable a wireless terminal 100 to interface with a multi-media subsystem 40 via WAP 30. As a result, the wireless terminal 100 may exchange information with various multi-media elements, such as the Internet 50, a PSTN/ISDN 60, etc., without requiring a wire interface between the wireless terminal 100 and the multi-media subsystem 40. As a result, a user may browse the Internet 50, check email, establish a voice over IP call, etc., from any region that supports short-range wireless networks.

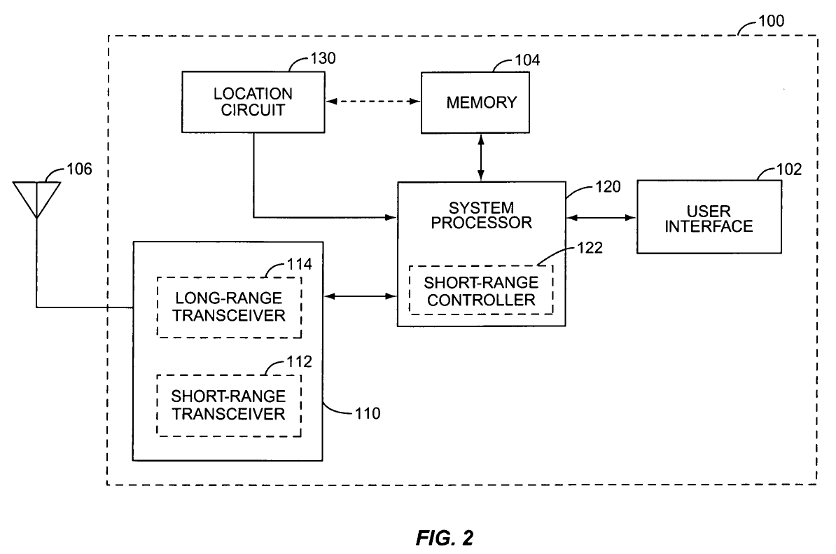

FIG. 2 illustrates a block diagram of one exemplary wireless terminal 100 according to the present invention. As used herein, the term “wireless terminal” represents any wireless device capable of wireless communication. A non-limiting list of wireless terminals includes a cellular radiotelephone with or without a multi-line display; a Personal Communication System (PCS) terminal that may combine a cellular radiotelephone with data processing, facsimile, and data communication capabilities; a Personal Digital Assistant (PDA) that can include a radiotelephone, pager, Internet/intranet access, web browser, organizer, calendar, and/or a global positioning system (GPS) receiver; and a laptop and/or palmtop receiver or other appliance capable of long-range and short-range wireless communication.

Wireless terminal 100 includes a user interface 102, memory 104, antenna 106, transceiver 110, system processor 120, and location circuit 130. User interface 102 enables the user to interact with and control wireless terminal 100. The user interface 102 may include a display, one or more user input devices, such as a keypad, joystick, etc., a microphone, and/or a speaker.

Antenna 106, coupled to transceiver 110, receives and transmits wireless signals to RAN 20 and/or WAP 30. Transceiver 110 preferably includes baseband processing circuits to process signals received by the transceiver 110. Alternatively, baseband processing circuits may be incorporated in the system processor 120.

As shown in FIG. 2, transceiver 110 includes a long-range transceiver 114 and a short-range transceiver 112. Long-range transceiver 114 represents a fully functional cellular radio transceiver that operates according to any known cellular standard, including the standards known generally as the GSM, GPRS, TIA/EIA-136, cdmaOne, cdma2000, UMTS, and Wideband CDMA. Short-range transceiver 112 transmits and receives wireless signals between wireless terminal 100 and WAP 30 or other wireless port over a short distance, e.g., less than 1000 feet. For example, short-range transceiver 112 may comprise a WLAN transceiver that operates according to IEEE 802.11 standards to enable wireless terminal 100 to interface with multi-media subsystem 40 via WAP 30. While FIG. 1 shows a single antenna 106 for both transceivers 112, 114, it will be appreciated by those skilled in the art that antenna 106 may comprise one or more antennas for each of the short-range transceiver 112 and the long-range transceiver 114.

System processor 120 performs various processing tasks, including controlling the overall operation of wireless terminal 100 according to programs stored in memory 104. The system processor 120 may be implemented in hardware, firmware, software, or a combination thereof, and may comprise a single microprocessor or multiple microprocessors. The microprocessors may be general purpose microprocessors, digital signal processors, or other special purpose processors. Functions performed by system processor 120 may include signal processing, image processing, and control of the overall operation of wireless terminal 100. In accordance with the present invention, and as discussed in greater detail below, system processor 120 may include a short-range controller 122. While FIG. 2 illustrates a specific short-range controller integrated with system processor 120, those skilled in the art will appreciate that the function of short-range controller 122 may be incorporated with the other functions of system processor 120. Further, those skilled in the art will appreciate that short-range controller 122 may be implemented independently from system processor 120.

Memory 104 may include both random access memory (RAM) and read-only memory (ROM). Computer program instructions and data required for operation of wireless terminal 100 may be stored in non-volatile memory, such as EPROM, EEPROM, and/or flash memory, which may be implemented as discrete devices, stacked devices, or integrated with system processor 120.

In accordance with the present invention, short-range controller 122 configures short-range transceiver 112 to operate within one or more operating parameters corresponding to a region of operation associated with a location of wireless terminal 100. Therefore, as a wireless terminal 100 moves from one region to another region, short-range controller 122 modifies the configuration of the short-range transceiver 112 to conform to the requirements of the current region of operation.

Wireless terminal 100 may determine the region of operation according to any known means. In one exemplary embodiment, the wireless terminal 100 may extract location information from control information broadcast to the wireless terminal 100 via the long-range wireless network. As understood by those skilled in the art, when a wireless terminal 100 enters a cellular network, RAN 20 broadcasts control information to the wireless terminal 100. Wireless terminal 100 may use this control information to identify the network, identify a region of operation, establish a connection within the network, etc. For example, in a GPRS network, the broadcast control information includes a Mobile Country Code (MCC) and a Mobile Network Code (MNC). Based on the MCC/MNC information, the wireless terminal 100 may determine the identity and location of the network. For example, an MCC/MNC=310/150 translates to Cingular® in the United States.

Wireless terminal 100 typically uses the MCC/MNC information to determine if wireless terminal 100 is subject to roaming charges, long distance charges, and/or various other fees associated with a user's particular cellular service plan. However, according to the present invention, wireless terminal 100 may also use this broadcast control information to identify a region of operation associated with a location of wireless terminal 100 for short-range wireless activities. To that end, in one exemplary embodiment, wireless terminal 100 may include a location circuit 130 as shown in FIG. 2. While FIG. 2 illustrates a location circuit 130 separate from the system processor 120, those skilled in the art will appreciate that location circuit 130 may be incorporated with system processor 120.

After receiving the broadcast control information at long-range transceiver 114, system processor 120 provides this information to location circuit 130. Location circuit 130 uses the MCC and/or MNC information to determine the current region of operation associated with the location of the wireless terminal 100. Table 1 below lists several MCCs and their corresponding regions.

TABLE 1
Mobile Country Codes

| MCC | Region of Operation |
|---|---|
| 310-316 | United States |
| 240 | Sweden |
| 461 | China |
| 440, 441 | Japan |
| 208 | France |
| 262 | Germany |
| 214 | Spain |

The above discusses how location circuit 130 may use the broadcast control information to determine a region of operation associated with the location of wireless terminal 100. However, the present invention may use other means to determine the region of operation. For example, according to another embodiment, location circuit 130 may comprise a GPS (Global Positioning System) that determines a location of the wireless terminal 100 according to any conventional means. Alternatively, an external device may provide wireless terminal 100 with coordinates corresponding to its location. In any event, location circuit 130 processes the location information to identify the region of operation.

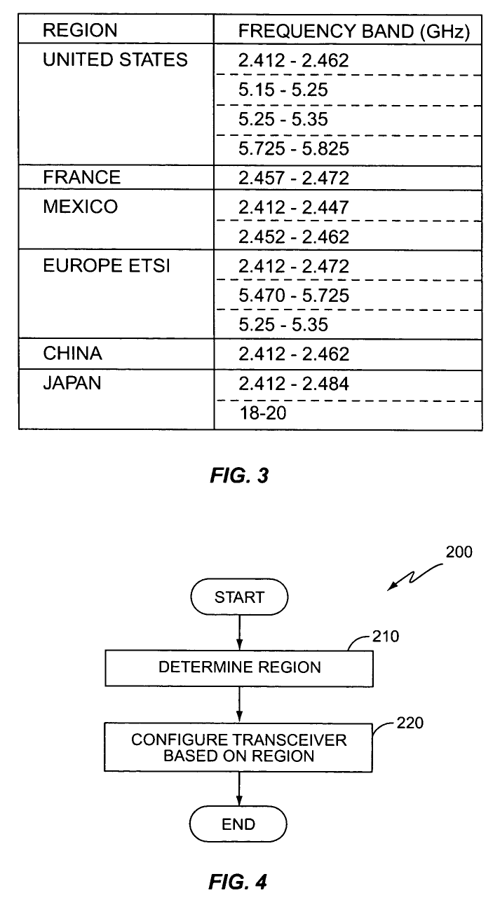

Based on the region of operation associated with the location of wireless terminal 100, location circuit 130 determines the appropriate operating parameters, such as transmission frequency band, transmission power, etc., for short-range transceiver 112. Location circuit 130 may use any means to identify the particular operating parameters appropriate for the current region of operation. For example, location circuit 130 may request operating parameter information from an external source, such as RAN 20, based on the determined region of operation. Alternatively, location circuit 130 may access a look-up table stored in memory 104 to determine the appropriate operating parameters. FIG. 3 illustrates one exemplary look-up table that associates particular frequency bands with specific countries/regions. Those skilled in the art will appreciate that this table is for illustrative purposes only. Other look-up tables that include different and/or additional operating parameters, i.e., transmit power, bit rate, etc., may also be used.

As shown in FIG. 3, if location circuit 130 determines that wireless terminal 100 is operating in France, for example, then location circuit 130 determines that the short-range transceiver must operate within the 2.457-2.472 GHz frequency band. As another example, if location circuit 130 determines that wireless terminal 100 is operating in Mexico, then location circuit 130 determines that the short-range transceiver must operate within the 2.412-2.447 GHz frequency band for indoor transmissions, or within the 2.452-2.462 GHz frequency band for both indoor and outdoor transmissions. In any event, short-range controller 122 configures the short-range transceiver 112 to operate within the operating parameters identified by location circuit 130.

The above discusses specific devices that may be used to configure the operating parameters of a short-range transceiver 112 corresponding to a current region of operation. However, those skilled in the art will appreciate that the present invention is not limited to these specific devices. The present invention may be implemented in any hardware, software, or combination of hardware and software that implements the general process 200 of the present invention, illustrated in FIG. 4. In particular, the present invention may be implemented in any hardware and/or software system that first determines the region of operation associated with the location of wireless terminal 100 (block 210) and then configures the short-range transceiver 112 to operate according to one or more operating parameters corresponding to the determined region of operation (block 220).

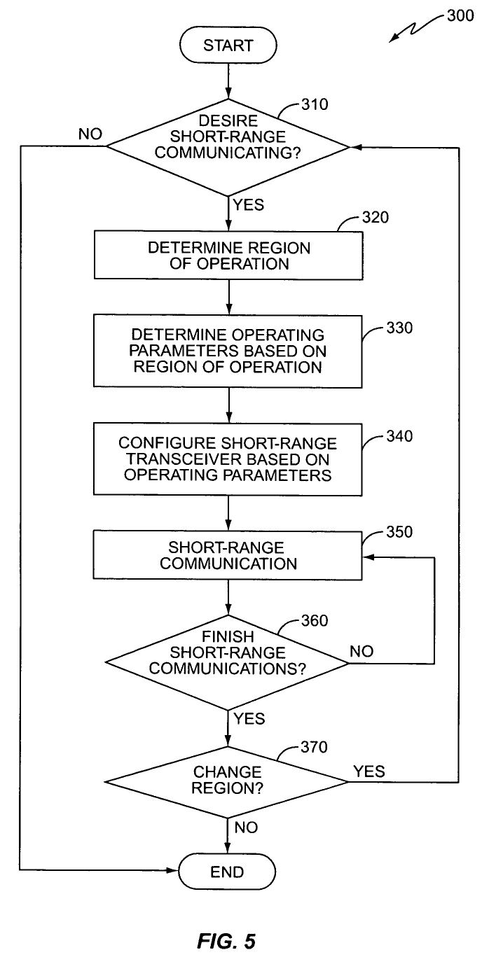

FIG. 5 illustrates another exemplary process 300 for a specific embodiment of the general process 200. This exemplary process is for illustrative purposes only and is not intended to be limiting. When wireless terminal 100 desires to participate in short-range communications (block 310), such as WLAN communications, location circuit 130 determines the region of operation associated with the location of the wireless terminal 100 (block 320). For example, long-range transceiver 114 may receive and provide the MCC to location circuit 130. Based on the location information, location circuit 130 determines the appropriate operating parameters for short-range transceiver 112 (block 330). For example, location circuit 130 may use a look-up table stored in memory 104 to determine the appropriate operating parameters.

Short-range controller 122 then configures the short-range transceiver 112 based on the determined operating parameters (block 340). Once configured, short-range transceiver 112 may communicate within the short-range wireless network 32 (block 350). For example, short-range transceiver 112 may communicate with WAP 30 to enable the user to browse the Internet or check email. This process continues until the short-range communications are terminated (block 360). Further, if the region changes (block 370), the short-range controller 122 reconfigures the short-range wireless transceiver as necessary (blocks 310-360).

The above invention is described in terms of a wireless terminal 100 having a short-range transceiver 112 that communicates within a short-range wireless network and a long-range transceiver 114 that communicates within a long-range wireless network. It will be appreciated by those skilled in the art that the short-range wireless network may comprise any known short-range wireless network, such as a WLAN complying with any of the 802.11 standards, a HiperLAN network, a Bluetooth® network, an infrared network, etc.

Further it will be appreciated that location circuit 130 may determine a location or current region of operation according to any known means. As such, location circuit 130 may determine the region of operation using an MCC or any other country/region information broadcast by a RAN 20 in a long-range wireless network. Further, location circuit 130 may determine the region of operation using a GPS or other position determining means.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of configuring a short-range wireless transceiver in a wireless terminal for operation in a short-range wireless network, the method comprising:
determining a region of operation associated with a location of the wireless terminal; and
configuring the short-range wireless transceiver to operate according to one or more operating parameters corresponding to the region of operation.

2. The method of claim 1 wherein configuring the short-range wireless transceiver comprises configuring the short-range wireless transceiver to operate within a predetermined frequency band corresponding to the region of operation.

3. The method of claim 2 wherein configuring the short-range wireless transceiver to operate within the predetermined frequency band comprises configuring the short-range wireless transceiver to operate within at least one of a 2.4 GHz and a 5 GHz frequency band.

4. The method of claim 1 further comprising receiving location information via a cellular transceiver, wherein determining the region of operation comprises determining the region of operation corresponding to the location information.

5. The method of claim 4 wherein the location information comprises a mobile country code.

6. The method of claim 1 wherein determining the region of operation comprises processing location coordinates provided by a location circuit to determine the region of operation.

7. The method of claim 6 wherein the location coordinates comprise global positioning system coordinates.

8. The method of claim 1 further comprising using a look-up table to determine the one or more operating parameters corresponding to the region of operation.

9. The method of claim 1 further comprising receiving the one or more operating parameters via a long-range wireless interface based on the region of operation.

10. The method of claim 1 wherein configuring the short-range wireless transceiver comprises configuring the short-range wireless transceiver to operate within a predetermined transmit power range corresponding to the region of operation.

11. The method of claim 1 wherein the short-range wireless network comprises a wireless local area network.

12. A wireless terminal comprising:
a short-range transceiver configured to transmit and receive wireless signals within a short-range wireless network; and
a controller to configure the short-range transceiver to operate within one or more operating parameters corresponding to a region of operation associated with a location of the wireless terminal.

13. The wireless terminal of claim 12 wherein the one or more operating parameters comprise at least one of a frequency band and a transmit power.

14. The wireless terminal of claim 12 wherein the region of operation includes at least one country.

15. The wireless terminal of claim 12 further comprising a cellular transceiver configured to receive control information corresponding to the location of the wireless terminal.

16. The wireless terminal of claim 15 further comprising a location circuit configured to determine the region of operation based on the received control information.

17. The wireless terminal of claim 15 wherein the received control information includes a mobile country code.

18. The wireless terminal of claim 15 wherein the cellular transceiver further receives the one or more operating parameters via a cellular network corresponding to the region of operation.

19. The wireless terminal of claim 12 further comprising a global positioning system circuit to determine location information corresponding to the location of the wireless terminal.

20. The wireless terminal of claim 12 further comprising memory to store a parameter table that cross-references different regions of operation with one or more different operating parameters.

21. The wireless terminal of claim 20 wherein the controller is further configured to look up the one or more operating parameters in the parameter table based on the determined region of operation.

22. The wireless terminal of claim 12 wherein the short-range wireless network includes at least one of a wireless local area network, an ad hoc network, and a Hiper local area network.

23. The wireless terminal of claim 12 wherein the wireless terminal comprises a cellular telephone.

24. A cellular telephone comprising:
a cellular transceiver configured to transmit and receive cellular signals within a cellular network;
a short-range wireless transceiver configured to transmit and receive wireless signals within a short-range wireless network; and
a controller to configure the short-range wireless transceiver to operate within one or more operating parameters based on control information received by the cellular transceiver.

25. The cellular telephone of claim 24 wherein the control information includes a mobile country code that identifies a region of operation associated with a location of the wireless terminal.
